(19) United States
(12) Patent Application Publication
(10) Pub. No.: US 2006/0182935 A1
(43) Pub. Date: Aug. 17, 2006

(54) Methods of forming decouplers for vehicle interior components

(76) Inventors: Graham Tompson, Northville, MI (US); Surendra Khambete, West Bloomfield, MI (US); William Griffin, Indian Trail, NC (US); Fred Skidmore, Marion, NC (US); Sandip Mehta, Canton, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/224,695

(22) Filed: Sep. 12, 2005

Related U.S. Application Data
(63) Continuation of application No. PCT/US04/07024, filed on Mar. 9, 2004.
Application No. PCT/US04/07024 is a continuation of application No. 10/775,547, filed on Feb. 10, 2004, now abandoned.
(60) Provisional application No. 60/454,203, filed on Mar. 12, 2003.

(51) Int. Cl. B32B 7/02

(52) U.S. Cl. 428/174; 428/218; 264/119; 425/508

(57) ABSTRACT

A method of manufacturing an article, such as a decoupler for a vehicle interior trim component, is disclosed. The method comprises the conveying of materials into an enclosure to form a preform having a shape of the enclosure, heating the preform to a temperature such that adjacent materials may bond to one another upon cooling and forming the heated preform into a predetermined three-dimensional configuration via a mold. The enclosure has a perforated portion and at least one panel movable relative to the enclosure so as to selectively expose portions of the perforated portion. The density of the preform may be varied as the at least one panel is moved to expose the perforated portion of the enclosure. A system for manufacturing articles, such as decouplers, of the present invention is also disclosed.

### CROSS REFERENCE TO RELATED APPLICATIONS

This application is a Continuation of International Application No. PCT/US04/007024 filed Mar. 9, 2004, and published Sep. 23, 2004 as International Publication No. WO 2004/080749, designating the United States, and which claims priority to U.S. patent application Ser. No. 10/775,547 filed Feb. 10, 2004 (now abandoned) and claims the benefit of U.S.

Provisional Application Ser. No. 60/454,203 filed Mar. 12, 2003, the teachings of which are incorporated by reference.

### TECHNICAL FIELD

The present invention relates generally to vehicles, particularly to trim components for vehicles, and more particularly to noise attenuation in vehicles.

### BACKGROUND OF THE INVENTION

It is generally considered desirable to reduce the level of noise within a vehicle passenger compartment. External noises, such as road noise, engine noise, vibrations, etc., as well as noises emanating from within passenger compartments, may be attenuated through the use of various acoustical materials. Accordingly, sound attenuating materials for vehicles, such as automobiles, are conventionally used in the dashboard, in conjunction with carpeting for floor panels, in the wheel wells, in the trunk compartment, under the hood, and as part of the headliner.

Recently, a lot of emphasis has been placed on the acoustic properties of vehicle trim components, such as carpeting and dash insulators, because of customer requirements for quieter passenger compartments. Carpeting used to cover the floor areas of vehicles, such as automobiles, is conventionally molded into a non-planar three dimensional contoured configuration which conforms to the contours of the vehicle floor so as to fit properly. Dash insulators are mounted to a vehicle firewall which separates the passenger compartment from an engine compartment. Dash insulators are designed to reduce the transmission of noise and heat from the engine compartment into the passenger compartment.

A foam or fibrous layer of material referred to as a decoupler is typically attached to the backside of vehicle dash insulators and carpeting to assist in the sound attenuation. The decoupler may act as an isolator between adjoining layers. Decouplers may be required to have complex shapes and configurations and, as such, may be time-consuming and expensive to manufacture. Vehicle manufacturers are constantly looking for ways to reduce costs and complexity associated with vehicle manufacturing. Moreover, vehicle manufacturers are constantly looking for ways to reduce noise within passenger compartments while reducing weight of trim components. Accordingly, there is a need for acoustical insulation materials for use within vehicles that exhibit superior sound attenuating properties, while also being lightweight and low in cost.

### SUMMARY OF THE INVENTION

In view of the above, systems and methods of forming articles of controlled density, for instance decouplers for interior trim components, are provided. According to embodiments of the present invention, a method of manufacturing an article such as a decoupler for a vehicle interior trim component includes: ascertaining the acoustic properties of a portion of a vehicle passenger compartment to identify portions thereof requiring enhanced sound attenuation; conveying material into an enclosure to form a preform having a desired shape and density profile; heating the preform to a temperature such that upon cooling adjacent materials may bond to one another; and forming the heated preform into a predetermined three-dimensional decoupler configuration via a mold. The predetermined configuration is based upon the physical dimensions of the vehicle in the area where the decoupler will be installed and the sound attenuation desired in that area.

According to embodiments of the present invention, an enclosure into which material is conveyed has a perforated portion and one or more panels are movable relative to the enclosure so as to selectively expose portions of the perforated portion as material is conveyed via an airstream into the enclosure to form a preform. The air exits the enclosure through the perforated portion and allows the loose material to collect in that area of the enclosure. The density of selected areas of the preform formed within the enclosure is controlled by the rate and/or duration at which the perforated portion of the enclosure is exposed. The density also may be a function of the pressure in the air stream which conveys the loose material and by the concentration of the material in the air stream. According to embodiments of the present invention, the density of selected areas of the preform may be increased in areas identified as requiring enhanced sound attenuation. Thus, for each selected area of a decoupler identified as requiring enhanced sound attenuation, pressure may be increased along with the concentration of material conveyed, and/or the rate of movement of the panel is slowed, and/or the duration of exposure of the perforated portion is increased, so that more material is conveyed into that particular area of the enclosure and collected to form the preform. In addition, a preform of varying cross section that is contoured may be formed and later compressed to provide additional densification and sound attenuation in specific areas.

Furthermore, the delivery of material may be adjusted by controlling the opening diameter of the output section of the duct that provides the airflow to the enclosure, and such airflow may also be selectively pulsed or varied in rate to again control the amount of material collecting at a given location in the enclosure.

According to embodiments of the present invention, a heated preform may be optionally combined with a heated interior trim component (e.g., dash insulator, carpeting, etc.) and then molded together into a predetermined three-dimensional interior trim configuration, including a decoupler, via a mold.

According to embodiments of the present invention, a method of manufacturing an article having a controlled density, preferably a preform or decoupler, includes filling an enclosure with material, e.g. thermoplastic material, thermoset material, fibrous material, foam, woven material, nonwoven material, fibers of any type, and combinations thereof. Preferably, blends of fibers may be utilized. For example, different denier fibers may be used at different locations to achieve different acoustical performance. In addition, fibers of different material compositions may be used, as well as fibers having multiple material compositions within the same fiber (for instance, bicomponent fibers such as sheath/core, alternating segments, etc.) and blends thereof.

Reference to the conveying of “material” or “materials” should be understood to include the conveying of a single material, for instance in fiber form, or two or more materials either in fiber form or non-fibrous form. Furthermore, the materials used to fill the enclosure may be in nearly any form and shape, including but not limited to, fibers, clumps, chunks, tufts, beads, clusters, scraps, powder and pellets. The materials may also be of nearly any size and aspect ratio. In addition, it is preferably to control such size and aspect ratio such that they may be conveyed to the enclosure and retained in the enclosure by adjustment of the size of the openings in the perforated portions of the enclosure and to preferably provide an article with some degree of loft or reduced density.

Accordingly, the size and shape of the openings in the perforated portion of the enclosure may be selectively adjusted such that the materials having a variety of forms and shapes that are conveyed to the enclosure may be selectively collected in the enclosure to form a preform.

Decouplers according to embodiments of the present invention may be manufactured inexpensively and may replace expensive preformed batting, multiple layers of materials and other fibrous materials currently utilized in vehicles. Moreover, decouplers according to the present invention may utilize less material than conventional batting because material for sound absorption is strategically placed directly where it is needed providing a more efficient use of material. Thus, the combination of specific area density and localized part thickness are used to provide effective sound attenuation by selectively controlling the density and thickness at any selected location. As such, decouplers according to the present invention may be lighter in weight when compared with conventional decouplers and may be provided with variable thickness without the stacking of multiple layers. Decouplers according to embodiments of the present invention may have different acoustical profiles in different locations to suit the specific needs of a vehicle. The decouplers herein therefore provide the opportunity to control costs by targeting material, preferably fiber, placement at selected locations while avoiding the need for more expensive components such as binder layers or other additives or multiple layers in the overall decoupler composition. In addition, it should be understood in the context of the present invention, and with respect to functionality, reference to a decoupler includes any media which acts as a sound absorber or sound barrier or sound isolator or sound insulator or sound attenuator, or combinations thereof. Accordingly a decoupler includes any media that may effect sound.

### BRIEF DESCRIPTION OF THE DRAWINGS

The accompanying drawings, which form a part of the specification, illustrate key embodiments of the present invention. The drawings and description together serve to fully explain the invention.

FIGS. 1A-1B are flow charts of operations illustrating methods of manufacturing a decoupler, according to embodiments of the present invention.

FIG. 2 is a schematic illustration of a system for manufacturing decouplers for vehicle interior trim components, according to embodiments of the present invention.

FIG. 3 is an enlarged perspective view of the upstream end of a duct that connects the blower and the enclosure of FIG. 2.

FIG. 4 is a perspective view of the duct that connects the blower and the enclosure of FIG. 2.

FIG. 5 is a perspective view of the enclosure of FIG. 2 into which fibers are blown to produce a preform, and that illustrates the movable panels overlying the perforated portion.

FIGS. 6-7 illustrate the movable panels of FIG. 5 being moved so as to expose the perforated portion.

FIG. 8 is a top plan view of the enclosure of FIGS. 5-7 with the upper portion removed for clarity and illustrating a preform substantially formed therein

FIG. 9 illustrates the upper portion of the enclosure being moved to expose a preform.

FIGS. 10-15 illustrate various mold configurations for producing preforms and decouplers with different densities (FIGS. 10-11), contoured preforms and decouplers with different densities (FIGS. 12-13), and contoured preforms and decouplers with different densities and cross-sectional dimensions (FIGS. 14-15).

FIG. 16 is a schematic illustration of an assembly line for mass-producing decouplers for vehicle interior trim components, according to embodiments of the present invention.

FIG. 17 is a schematic diagram of the operation of a process controller used in the system of FIG. 16.

FIG. 18 is a flow chart describing the flow of information managed by the process controller of FIG. 17.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, the thickness of lines, layers and regions may be exaggerated for clarity. It will be understood that when an element such as a layer, region, substrate, or panel is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like when used herein are for the purpose of explanation only.

For elements common to the various embodiments of the invention, the numerical reference character between the embodiments is held constant, but distinguished by the addition of an alphanumeric character to the existing numerical reference character. In other words, for example, an element referenced at 10 in the first embodiment is correspondingly referenced at 10A, 10B, and so forth in subsequent embodiments. Thus, where an embodiment description uses a reference character to refer to an element, the reference character applies equally, as distinguished be alphanumeric character, to the other embodiments where the element is common.

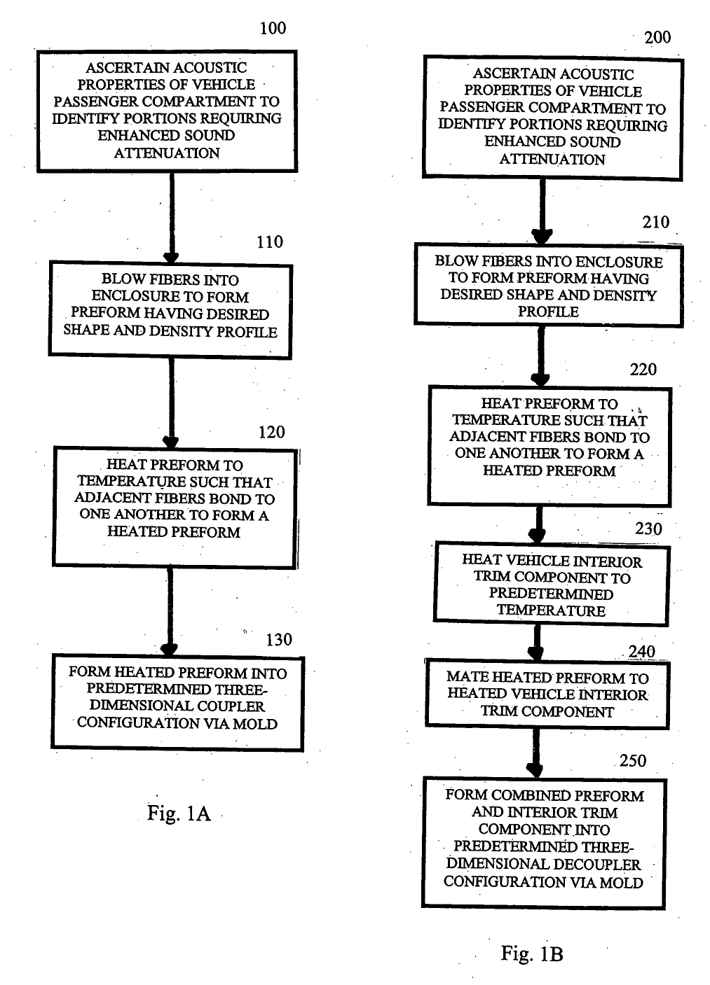

Referring now to FIG. 1A, a method of manufacturing a decoupler for a vehicle interior trim component, according to embodiments of the present invention, includes the steps of: ascertaining the acoustic properties of a portion of a vehicle passenger compartment against which an interior trim component is to be placed to identify portions thereof requiring enhanced sound attenuation (Block 100); blowing materials, preferably fibers, into an enclosure to form a preform having a desired shape and density profile (Block 110); heating the preform to a temperature such that adjacent materials upon cooling may bond to one another (Block 120); and forming the heated preform into a predetermined three-dimensional decoupler configuration via a mold (Block 130). Upon cooling of the three-dimensional decoupler configuration, the bonding of adjacent materials, preferably fibers, to one another provides shape retention of the predetermined configuration.

As noted, the present invention relies in part upon the step of heating the preform to a temperature such that upon cooling adjacent material or the preferred fibers bond to one another. This may be accomplished by a variety of methods, one of which is heating materials or fibers to a temperature such that adjacent materials or fibers bond to one another without melting. Elaborating on this concept, it can be appreciated that this is reference to the feature of employing an amorphous polymer, as part of the material or fiber mix, wherein the amorphous polymer itself does not have a defined melting point (Tm) sufficient to soften as a consequence of a true thermodynamic melting event, and provide bonding. Instead, since the polymer is amorphous, the softening may occur at a secondary transition temperature, e.g. the glass transition temperature (Tg), or at some other temperature. Those of skill in the art will therefore appreciate that heating of, for instance, fibers to a temperature such that the adjacent fibers bond to one another without melting may occur at a temperature above the Tg of a substantially amorphous polymer material within the fiber composition. Under such circumstances, the crystalline polymer fibers of the fiber mix remain non-melted, and the amorphous polymers heated at or above their Tg will provide the bonding necessary upon cooling.

Alternatively, it is contemplated that bonding may occur via the use of binders which themselves may be chemically reactive due to the introduction of heat. For example, one may optionally employ a binder system that includes a component, such as a polymeric precursor, which undergoes chemical crosslinking, as in the case of a thermoset type precursor. Alternatively, one may optionally elect to use a moisture cure system, wherein the component, such as a polymer resin, will, upon introduction of heat and moisture, react and solidify upon cooling to provide binding within the preform.

Furthermore, one may also use a non-reacting binder system, e.g., a urethane water dispersion which can be used to coat a material or fiber and which upon heating and evaporation of the water provides bonding of material or adjacent fibers to form a preform. Again, this would be another example of material or fiber bonding without the material or fibers themselves melting.

In even further embodiment, one could also utilize a component binder, such as a polymer, with a melting point below the melting point of the material or fibers of the preform, which polymer binder would experience melting at elevated temperature to cause bonding of adjacent materials or fibers within the preform when cooled. Again, this would be yet another example of material or fiber bonding without the fibers of the preform themselves melting.

It can therefore now be noted that the acoustic properties of a portion of a vehicle passenger compartment may be ascertained by identifying areas of the passenger compartment where internal and external sounds have an intensity level that exceeds a threshold intensity level. This may include generating a sound intensity map of one or more portions of the passenger compartment. Sound intensity maps are well understood by those skilled in the art and need not be described further herein. For example, see “Noise Control: Measurement, Analysis and Control of Sound & Vibration”, Krieger Publishing Co., Malabar, Fla., 1994.

Referring now to FIG. 1B, a method of manufacturing a decoupler for a vehicle interior trim component, according to embodiments of the present invention, includes the steps of: ascertaining the acoustic properties of a portion of a vehicle passenger compartment to identify portions thereof requiring enhanced sound attenuation (Block 200); conveying materials, preferably fibers, into an enclosure to form a preform having a desired shape and density profile (Block 210); heating the preform to a temperature such that adjacent materials or fibers upon cooling may bond to one another (Block 220); heating a vehicle interior trim component (e.g., carpeting, dash insulator, etc.) to a predetermined temperature (Block 230); mating the heated preform to the heated vehicle interior trim component (Block 240); and forming the combined preform and interior trim component into a predetermined three-dimensional configuration via a mold (Block 250). Upon cooling of the three-dimensional interior trim configuration, including a decoupler, the bonding of adjacent material or fibers to one another provides shape retention of the predetermined configuration.

According to embodiments of the present invention, the various steps of the operations illustrated in FIGS. 1A-1B may be performed out of the illustrated order. For example, acoustic properties of one or more portions of a vehicle passenger compartment may be performed well in advance of the remaining steps of FIGS. 1A-1B. Furthermore, operations represented by various blocks may be performed substantially simultaneously. For example, a preform and an interior trim component may be heated (Blocks 220, 230) at substantially the same or different times.

According to embodiments of the present invention, an enclosure into which materials or fibers are conveyed has a perforated portion and one or more panels that are moveable relative to the enclosure in any direction so as to selectively expose portions of the perforated portion as materials or fibers are conveyed into the enclosure. The air steam, or for that matter, any other suitable carrying media such as a gas or fluid conveying the materials or fibers, exits the enclosure through the perforated portion, allowing the materials or fibers to collect in that area. In such regard, it should be appreciated that one could also simply gravity feed the enclosure with the material or fibers. For exemplary purposes only, air will be relied upon as a preferred media for conveying the preferred fibers.

Fiber or material density of a preform formed within the enclosure may therefore be preferably controlled by the rate at which the perforated portion of the enclosure is exposed (or that the panels are moved) and/or the duration for which the perforated portions are exposed. For example, an essentially uniform rate of panel movement exposing the perforated portion will provide a preform of essentially uniform density. Slowing or increasing the rate of removal of the panels allows the preform to be comprised of various sections having higher and/or lower material or fiber density. In addition, the rate at which materials or the preferred fibers may be fed to the enclosure from the blower also may affect the density of the preform. For example, should one introduce fibers at a relatively high rate (e.g. 40 lbs. min.) for a relatively long time, over a given perforation area, such would provide a more dense packing of fibers relative to a slower rate of fiber introduction (e.g. 10 lbs./min.) for a shorter period of time.

According to embodiments of the present invention, material or the preferred fiber density may be increased in areas of a decoupler identified as requiring enhanced sound attenuation. Thus, for each area of a decoupler identified as requiring enhanced sound attenuation, the pressure in the enclosure is increased (or the rate of panel movement is decreased) as materials or fibers are blown into that particular area of the enclosure as the preform is being formed. Moreover, different types, sizes, composition and physical features of materials or fibers can be used at different locations in a decoupler. For example, it is contemplated that the feed mix of materials or fibers can be selectively adjusted at any given time during fill of the enclosure to vary the type of materials or fibers delivered at a selected location within the enclosure. For example, the more dense the decoupler formed, and the finer the fibers, the higher the acoustic impedance. Furthermore, in the broad context of the present invention, the preform may be of contoured shape and compressed at selective levels during molding to further control and density specific areas.

Preferably, the fibers as the preferred material are conveyed into the enclosure by supplying loose fibers to an air steam emanating from an air blower. However, other means for conveying the fibers or other materials, including but not limited to, vacuum and combinations of vacuum and pressure may be used. Accordingly, it can also be appreciated that for a given three dimensional contoured shape, vacuum may be selectively applied at those locations for which material fill needs to be assisted beyond mere filling via air blowing. More specifically, for areas of a preform that are desirably of a higher density and greater thickness, one may prefer to utilize air flow and vacuum to improve fiber fill.

Material or the preferred fibers may be blown and/or drawn into the enclosure from more than one direction. For example, fibers may be blown into the enclosure from multiple directions and/or from multiple ducts or nozzles. In addition, it is further contemplated that various types of fibers may be conveyed into the enclosure selectively (e.g. specific fiber types supplied at each nozzle) through these ducts or nozzles to provide different preform compositions in selected areas of the preform. Further, specific nozzles or ducts may be selected at advantageous locations around the enclosure to deliver specific binder compositions of the types noted previously (e.g. amorphous fibers, reactive binders, low melting polymers, etc.).

As noted, various types and sizes of the preferred fibers may be utilized in accordance with embodiments of the present invention. For example, shoddy fibers may be utilized, as well as other scrap and non-scrap fibers of various lengths. Shoddy, being a mixture of various fibers, presents a unique opportunity to bond adjacent fibers together due to the varied properties of the fibers within the mixture. Preferably, as noted, the fibers are blown into the enclosure in a substantially loose state. The fibers may include, but are not limited to, synthetic fibers (thermoplastic and/or thermoset), natural fibers, recycled fibers and blends thereof. In addition, fibers having multiple compositions such as bicomponent fibers, including but not limited to, sheath/core, side-by-side, tipped, segmented pie, striped and islands-in-a-sea variants may be used, either alone, or in combination with synthetic and/or natural fibers may be used. In the case of bicomponent fibers, as alluded above, one of the components is strategically utilized to provide bonding after a heating and cooling profile. In addition, such bonding may occur without melting of the fibers of the preform, as the bicomponent may contain one polymer component that is amorphous and which does not have a Tm. Preferably, such bicomponent fiber comprises a sheath/core construction, with an inner core of crystalline poly(ethylene terphthalate) (PET) with a Tm of about 220° C. The sheath may comprise an amorphous polyester, with a Tg of about 70° C. Accordingly, the amorphous polyester may provide bonding when the system is heated above the Tg, and the other fibers do not themselves experience melting.

According to embodiments of the present invention, a carrier may be disposed within the enclosure and the material or preferred fibers blown into the enclosure to form a preform which is supported by the carrier. The carrier facilitates transporting the preform between the enclosure, the oven, and the mold. The carrier may be any of various types of materials. For example, the carrier may comprise an acoustic web of material. However, other types of materials that may be utilized as a carrier include, but are not limited to, scrim material, skin material, leather, plastic trim pieces, carpeting, shoddy, fiber batting, foam, etc. With respect to the carpeting, such carpeting is preferably porous, and includes a porous backing film, the film comprising a polyolefin polymer, and preferably, a polyethylene based material. In this manner, the preform is built up on the porous film layer of the carpeting. During heating of the preform, the film layer then serves to bond the preform to the carpet material. In addition, the carrier may also be a continuous (endless) belt which provides for support of the fibers during a continuous manufacturing process, which belt then does not become part of the decoupler.

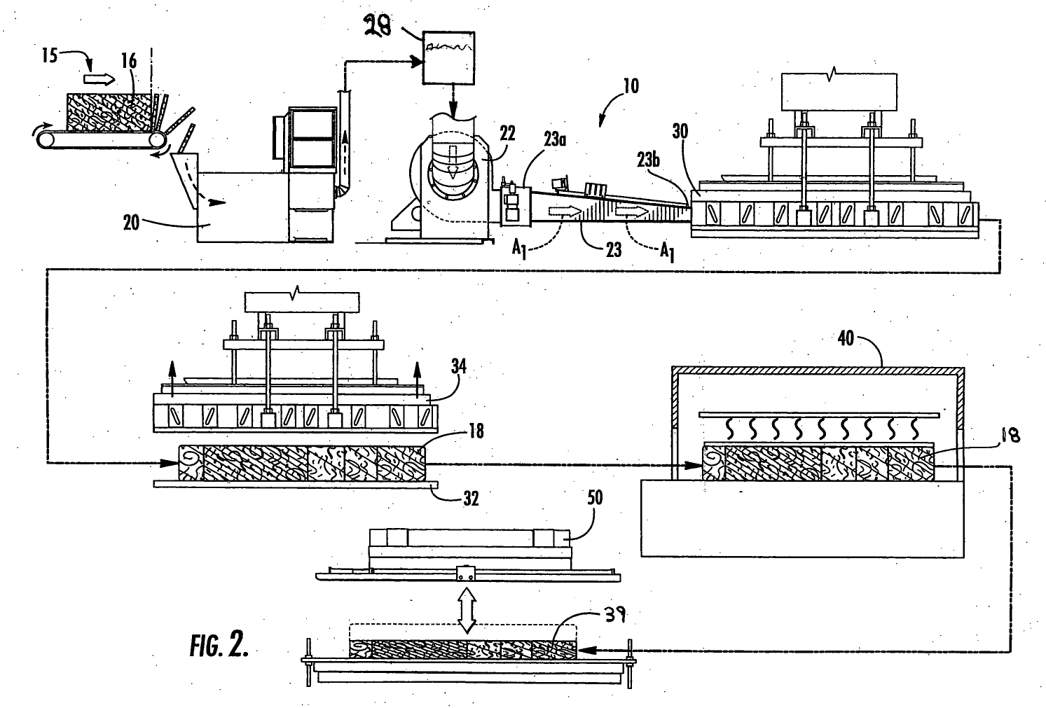

Referring now to FIG. 2, one preferred system 10 for manufacturing decouplers for vehicle interior trim components, according to embodiments of the present invention, is illustrated. The illustrated system 10 includes a fiber bale breaking station 15 where bales of fiber 16 are broken into smaller sections and then loaded into a fiber preparation station 20. Fiber preparation station 20 is configured to release the fibers from a generally compressed configuration (caused by being bundled) to an open, loose configuration and then to supply the loose fibers to a blower 22. Various types of devices may be utilized to implement the function of the fiber preparation station 20. For example, sets of rotating teeth or spikes may be utilized to open the fibers, as would be understood by those skilled in the art. One or more centrifugal (or other types) of fans may be provided to supply the open fibers to blower 22 or an equivalent movement source.

In connection with this step of the process (debating) it may be preferred to include a controlled amount of moisture, via misting, and/or an antistat and/or the use of deionized air to aid in preventing the fibers from reverting to a compacted state prior to introduction into the enclosure. An accumulator 28 may preferably be utilized to feed the blower 22. The accumulator may preferably include a photoelectric detector to control the amount of fibers remaining in the accumulator for introduction into the enclosure.

Blower 22 is configured to blow the loose fibers into an enclosure 30 to form a preform 18 having the shape of the enclosure. In the illustrated embodiment, blower 22 and enclosure 30 are in fluid communication via duct 23. Flow of fibers through the duct 23 and into the enclosure 30 via the airstream is indicated by arrows A₁. Optionally, the air stream itself may be heated or cooled as desired.

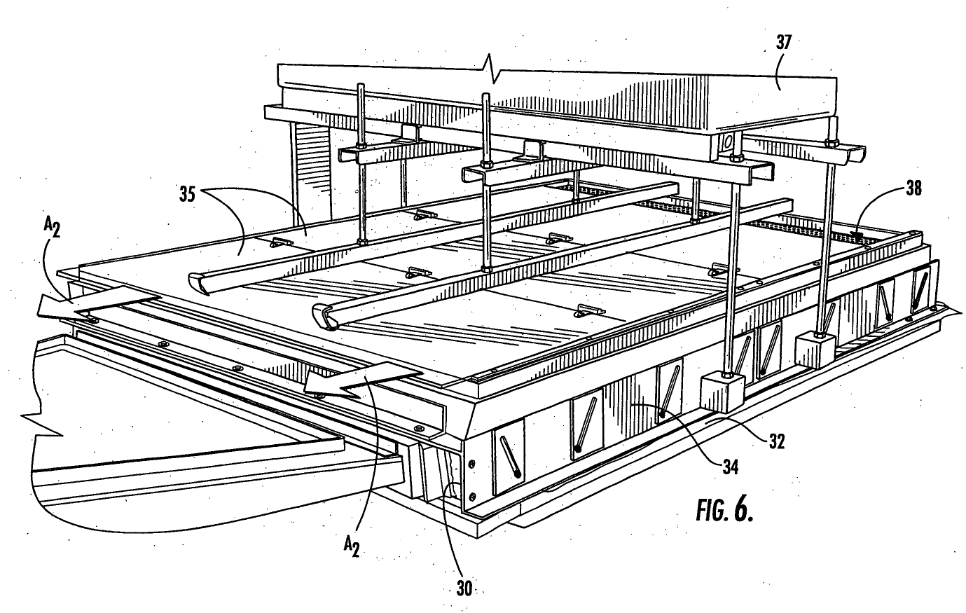

As will be described below, the enclosure 30 has a perforated portion (38, FIG. 6) and one or more panels (35, FIG. 6) that are moveable relative to the enclosure so as to selectively expose portions of the perforated portion, and thereby control the preform density by allowing air to flow out of the enclosure through the exposed perforated portion causing more material or preferred fibers to collect in an area as the pressure in that area increases. The illustrated enclosure 30 is defined by a base 32 and a movable upper portion 34. Accordingly it should be appreciated that in the context of the present invention, the feature of employing an enclosure corresponds to any structure that allows for collection of material or fibers such that the material or fibers can assume the configuration of such enclosure. Therefore, it does not necessarily require walls on all sides.

The illustrated system 10 also includes an oven 40 and mold 50. The oven 40 heats (e.g., via heated air, infrared radiation, etc.) the preform 18 (after being removed from the enclosure 30) to a temperature such that adjacent materials or fibers upon cooling may bond to one another. As noted above, this is preferably accomplished by use of an amorphous polymer component that itself does not have a Tm. In addition, preferably, during heating in the oven, the preform may be initially reduced in thickness, at a level of between 1-75%, and at any increment therebetween. In a most preferred embodiment, the thickness of the preform may be reduced about 40-60% across its entire cross-section.

For example, in a preferred embodiment, a shoddy fiber blend was prepared with 55 wt. % cotton/polyester mix combined with 45 wt. % bicomponent sheath/core PET, where the sheath comprises an amorphous polyester and the core comprises a crystalline PET fiber component. The temperature required to allow such fiber blend to bond was about 390° F. However, it can be appreciated that various temperatures will be required for various different types of materials, which materials are preferably fibers.

After being removed from the oven 40, the mold 50 forms the heated preform 18 into a predetermined three-dimensional decoupler configuration 39 by closing over the preform and preferably compressing it to desired shape and density. Upon removal from the mold, and cooling, the bonding of the adjacent material such as fibers to one another is substantially complete and causes the decoupler to essentially retain the shape of the mold.

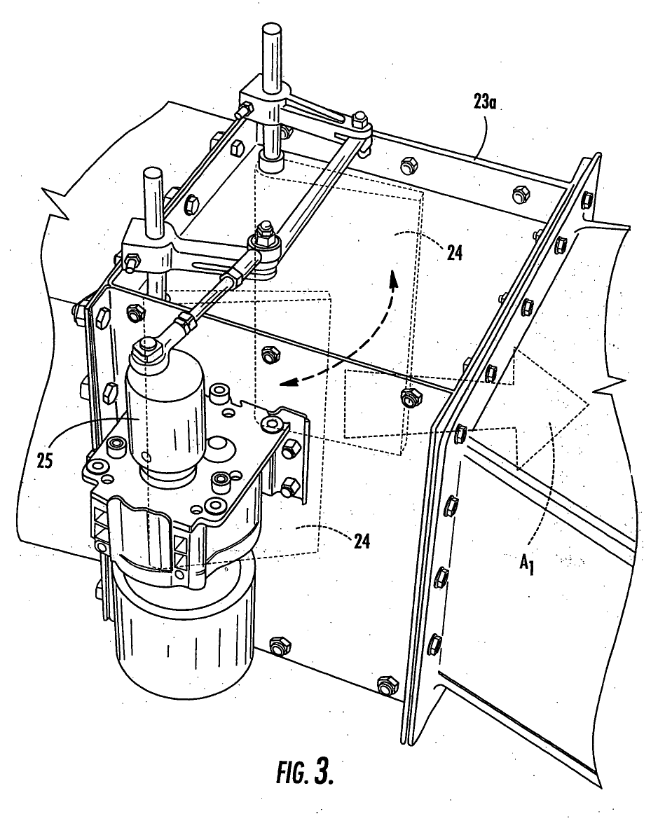

FIG. 3 is an enlarged, perspective view of the upstream end 23a of connecting duct 23. Disposed within the upstream end 23a are, preferably, a pair of vanes 24 that may oscillate back and forth via motor 25. The oscillating motion of the vanes 24 causes the loose fibers or other materials to flow more evenly within duct 23 providing a more even distribution of materials across enclosure 30. Various devices for causing even flow may be utilized in accordance with embodiments of the present invention. Embodiments of the present invention are not limited to the illustrated vanes 24. For example, a single vane may be provided, and/or oscillation motion may be performed in another direction (e.g., up and down).

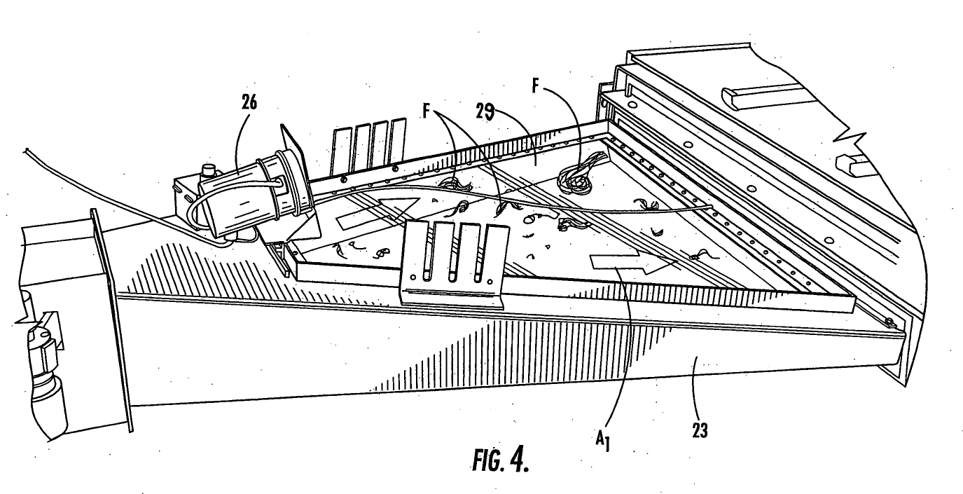

FIG. 4 is a partial perspective view of duct 23. The illustrated duct 23 has a transparent window 29 that allows an operator to view materials or fibers F being blown into the enclosure 30. A pressure gauge 26 is mounted on the illustrated duct 23 and is configured to measure the pressure within the duct 23 and/or within the enclosure.

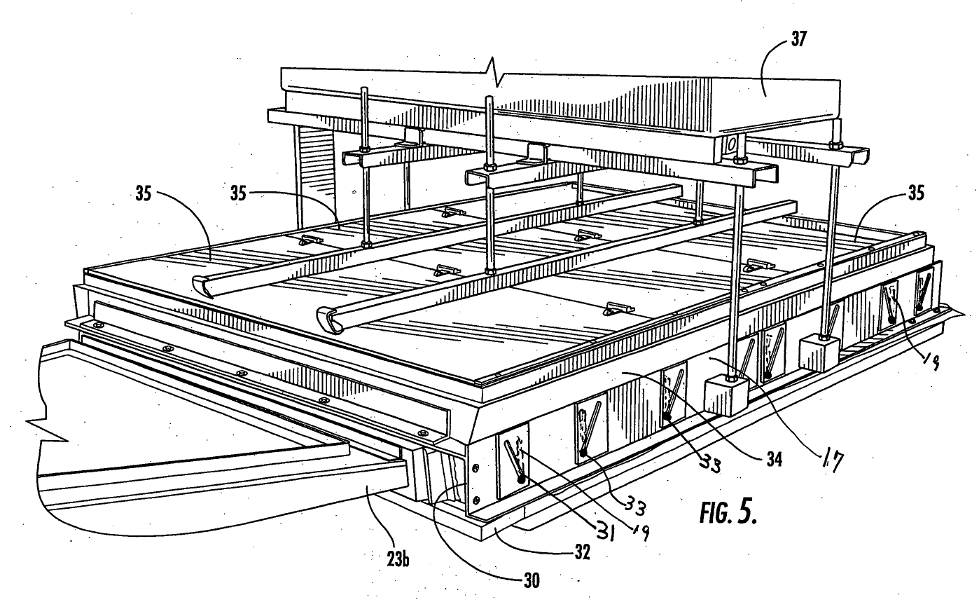

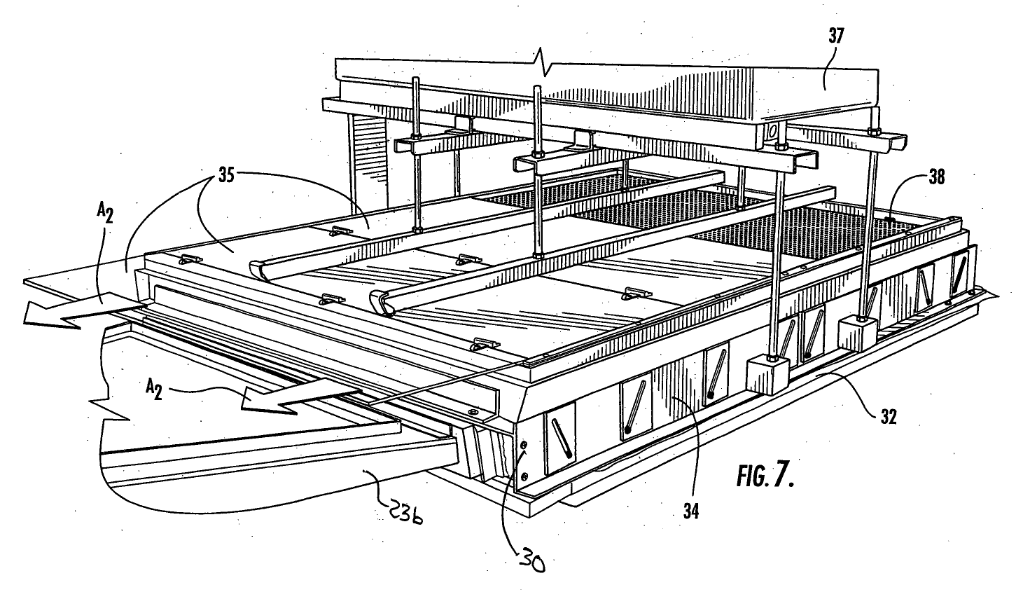

FIG. 5 is a perspective view illustrating the base 32 and movable upper portion 34 in contacting relationship to form enclosure 30. The duct 23 is in fluid communication with the enclosure via duct end 23b. A plurality of movable panels 35 overlie a perforated portion 38 (see FIG. 6) of the enclosure upper portion 34. However, embodiments of the present invention are not limited to a plurality of panels 35. A single panel 35 may also be used. Further, the perforated portion may comprise any portion of the enclosure, top, bottom, side walls, etc., and combinations thereof, to direct material or fiber collection to a specific area where sound attenuation in the finished decoupler is desired. In addition, the height of the enclosure for accommodating the preform may be adjusted by moving upper portion 34 relative to the side walls 17 of the enclosure. Cover plates 31 overlie a slot in the side walls 17 which align with pins 33. The pins can move in the slot 19 to allow the aforementioned enclosure convenient height adjustment. Operation of the movable panels 35 will now be described with reference to FIGS. 6-7 below.

Upper portion 34 of enclosure 30 is configured to be raised and lowered relative to the base 32 via lifting mechanism 37, which is only partially illustrated for clarity, so that the preform 18 may be removed. As illustrated in FIG. 6, the panels may preferably slide to expose the perforated portion 38, allowing more airflow through that area of the enclosure. Alternatively, the panels may be moved in any direction relative to the enclosure rather than in a fore/aft direction. For example, the panels may alternatively be lifted, hinged, rotated or otherwise displaced, to expose selected areas of the perforated portion 38 where greater material or fiber density is desired. For lower density areas, the panels may be moved more quickly or the perforated portion exposed for a relatively short duration to reduce the collection of material, or fibers, as the case may be, in that area of the preform.

Alternatively, rather than exposing the perforated areas sequentially and continuously, it is contemplated herein that after exposure, selected regions of the perforated portions may be closed. In this manner, one can more reliably develop distinct density boundaries within the decoupler composition. For example, the panels 35 may selectively be opened and closed, across the perforated portion of the enclosure, to selectively collect fibers at such locations. This preferably includes panels that are hinged on one edge which extend over such selected area. The panels can therefore be hingedly moved to expose the perforations, and the time period for opening may be conveniently controlled by an associated processor or programmable logic controller (PLC). The opening and closing may be the same across the entire cross section of the enclosure, or timed differently, to thereby provide different density profiles in the preform.

In FIG. 6, fibers, as the preferred material, are shown being blown into the enclosure 30 and the panels 35 are being moved in the direction of arrows A₂ to reveal perforated portion 38. Air blown into the enclosure with the fibers exits the enclosure via perforated portion 38. Fiber density within the enclosure is controlled locally by the rate at which the panels 35 are moved which may be related to the pressure achieved in the air stream as fibers are blown into the enclosure 30 and by the concentration of fibers in the air as it is being conveyed. For greater fiber density in a particular portion of the enclosure, the movement of the panels the panels 35 is slower than for portions of the enclosure where less fiber density is desired. The speed of movement of the panels 35 may be related to the amount of pressure that is created within the enclosure as fibers are blown therein.

Alternatively, it should be recognized that the lower portion of the enclosure 32 may also have a perforated surface which contacts the lower portion of the preform such that one could draw a vacuum or blow air to assist in deposition of any material or the preferred fibers at such locations. For example, in the case of a contoured preform, with areas which are relatively more difficult to fill, the use of vacuum will assist in filling a thick and contoured preform geometry.

FIG. 7 illustrates panels 35 being moved further along the direction of arrows A₂ to reveal more of the perforated portion 38 as the preform is being formed within the enclosure 30. In the illustrated embodiment, panels 35 are preferably transparent so that operators can observe the forming of the preform within enclosure 30. However, embodiments of the present invention are not limited to transparent panels 35 or even slidable panels at all, as any covering comprising a surface of the enclosure that may be moved in any manner to selectively expose a portion of the perforated portion may suffice.

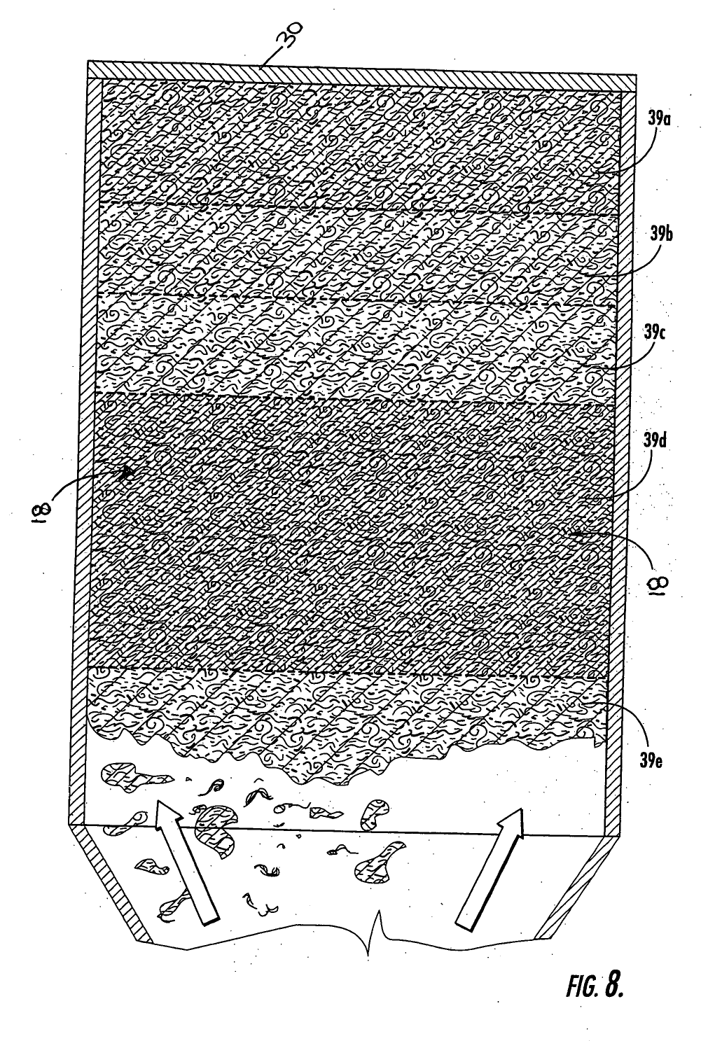

FIG. 8 is a top plan view of enclosure 30 with the upper portion 34 removed for clarity and illustrating a preform 18 substantially formed therein. The illustrated preform 18 has five portions or sections 39a-39e with respective different densities. Of course, the present invention is not limited to five portions, and may include as many portions as desired by a particular design choice.

As shown, section 39e is still being formed (i.e., fibers as the preferred material are still being blown into the enclosure 30) in FIG. 8. The fiber density of each portion was achieved by controlling the rate of movement of panels 35 at the location of each preform portion as described above. Preferably, each section 39a-39e may be defined by a hinged moveable panel which selectively opens and closes to provide the illustrated density pattern. Alternatively, the hinged moveable panels may be opened and closed for the same approximate duration, so that the density of the preform in each section is approximately the same.

In addition, while illustrated here as being comprised of rectangular areas having different densities, the preform 18 may be formed with selected areas of any desired shape (for instance, round, triangular, hexagonal, etc.) having different densities by configuring the moveable panels 35 to be of a corresponding shape, such that upon movement the airflow emanating from the exposed perforated portion 38 causes more or less material or the preferred fibers to be collected in that particular area.

For example, one may convey the preferred fibers into an enclosure to form a preform having a shape of the enclosure, wherein the enclosure has a panel containing one or a plurality of movable portions relative to the enclosure so as to selectively expose portions of the enclosure. Such movable portion may include, e.g. a plurality of round movable portions (e.g. iris or shutter-like) that selectively open and close across the surface of the panel thereby selectively controlling the air flow. In such opening, preferably, one may include mesh or other related structure to regulate the amount of air that blows through, and the amount of material or fiber retained in the enclosure.

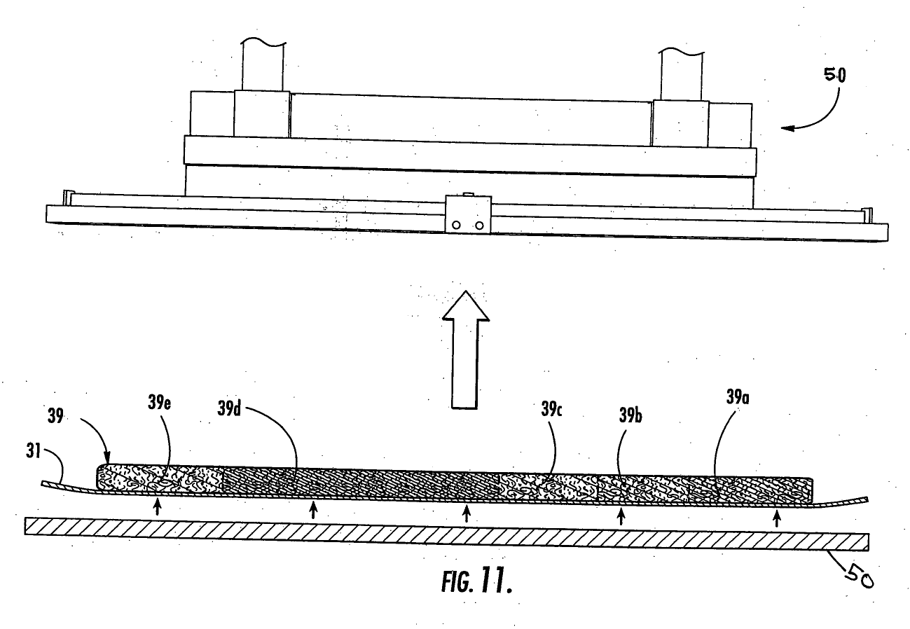

Although illustrated herein as a rectangular box-like shape, enclosure 30 may itself have various shapes, sizes and contours which may correspond to one or more preforms or decouplers. For instance, a large preform may be formed and cut to shape to provide multiple preforms or a thick preform may be skived to provide two or more thinner preforms. In other words, more than one preform or decoupler may be formed in the enclosure at one time. In addition, partitions, such as ribs, baffles and isolated cavities may be included within the enclosure to achieve complex cross-sectional configurations and shapes. For example, each of the illustrated sections 39a-39e of the illustrated decoupler 39 (see FIG. 11) could have different cross-sectional dimensions (e.g., different heights, widths and lengths etc.) formed by the outer walls of the enclosure.

Further, in a particularly preferred embodiment, a contoured preform of varied cross-section may be locally reduced in height in the molding process to further density specific areas of the preform requiring sound attenuation. This height reduction may vary depending upon the acoustical requirements and decoupler density at a desired location in the vehicle.

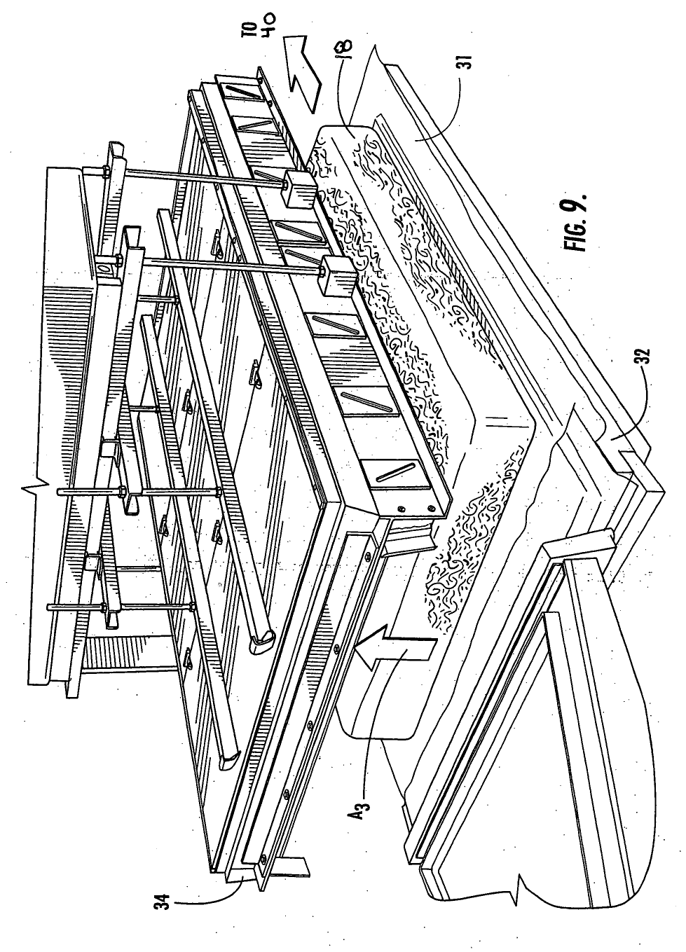

Referring now to FIG. 9, the enclosure upper portion 34 has been moved upwardly as indicated by arrow A₃ to reveal the preform 18. As illustrated, the preform 18 is supported by a carrier 31, and is being transported to an oven 40 (FIG. 2) for heating to allow adjacent materials or fibers upon cooling to bond to each other. The carrier may be a sheet of material, an endless belt or may be replaced by a manual operation (i.e., the preform may be carried by hand to another location).

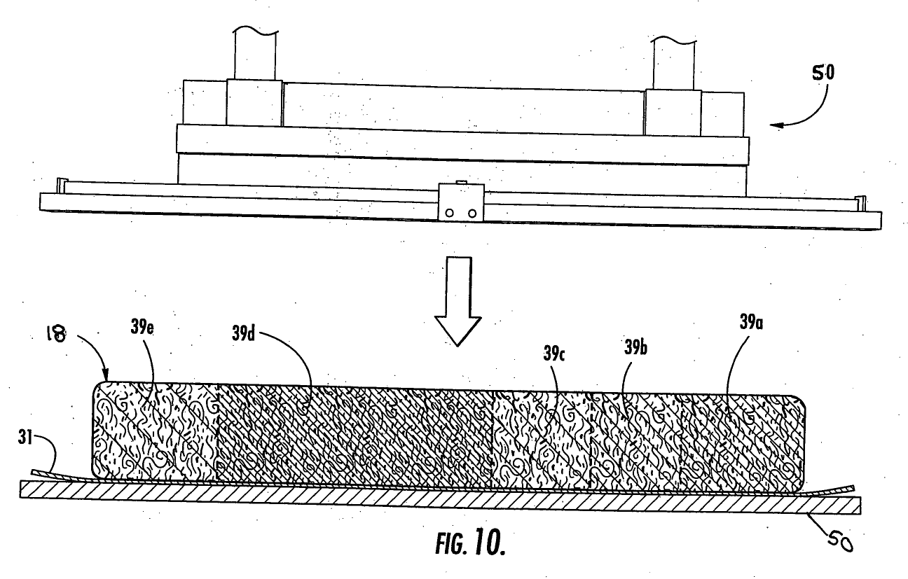

The heated preform 18 is then moved to a mold 50 (FIG. 2). FIGS. 10-11 illustrate a mold 50 configured to mold the preform 18 into a substantially rectangular, preferably compressed decoupler configuration 39. In the illustrated embodiment, sections 39a-39e of decoupler 39 have different respective densities, but the same compressed height after molding. Once removed from mold 50 and cooled (see FIG. 11), the decoupler 39 may be subjected to various trimming and/or other finishing operations known to those skilled in the art.

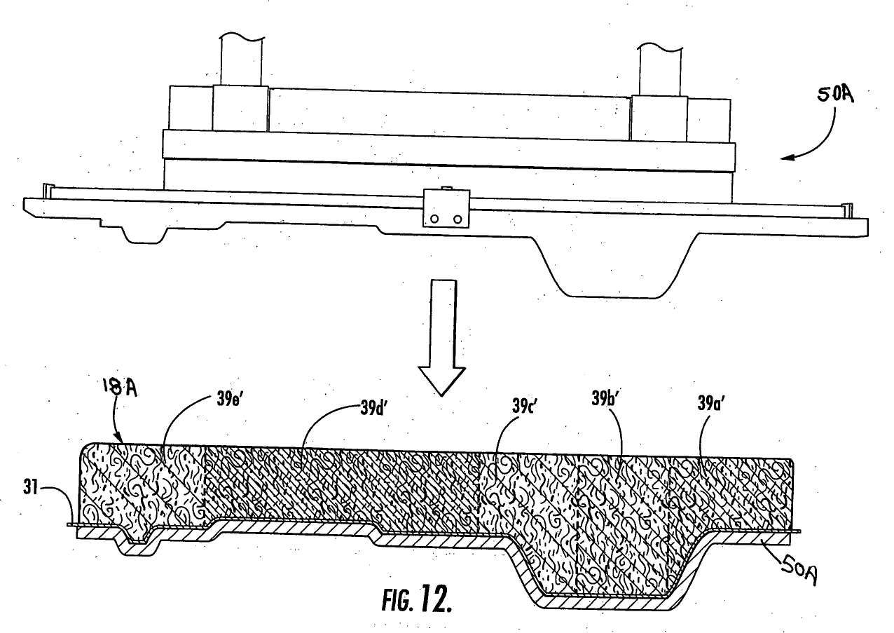

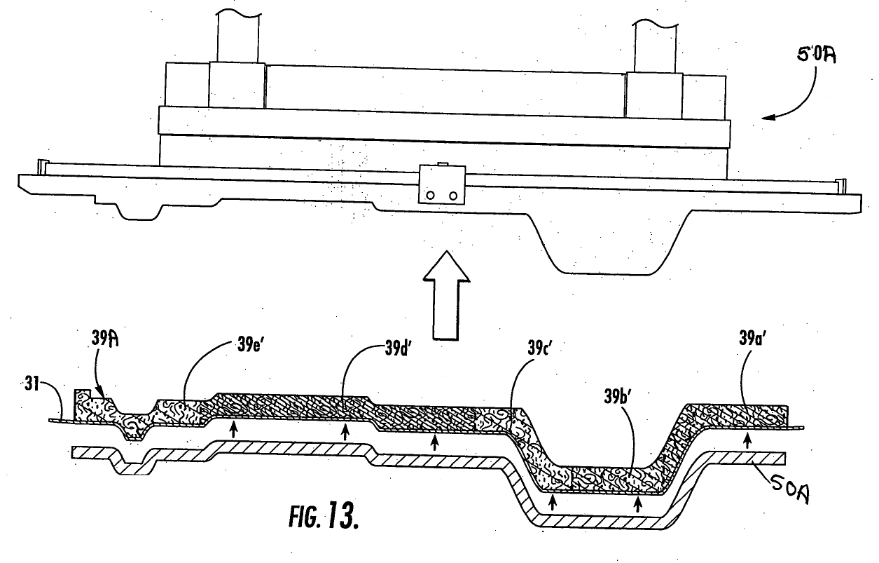

FIGS. 12-13 illustrate a mold 50A configured to mold a preform 18A having a substantially contoured configuration (FIG. 12) into a compressed configuration 39A with a substantially constant cross-sectional dimension (FIG. 13). In the illustrated embodiment of FIGS. 12-13, the decoupler 39A has a contoured configuration but sections 39a′-39e′ have different respective densities and the same height after molding.

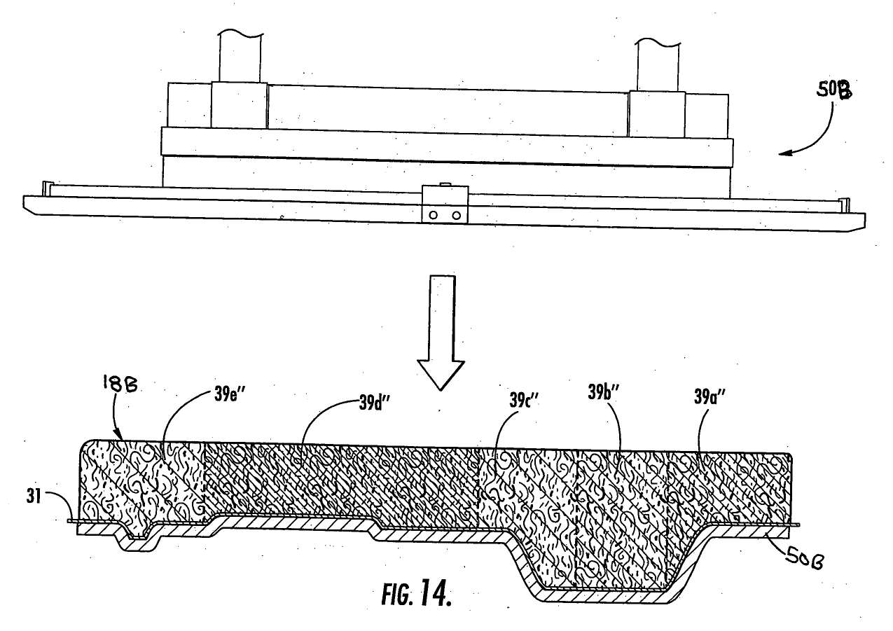

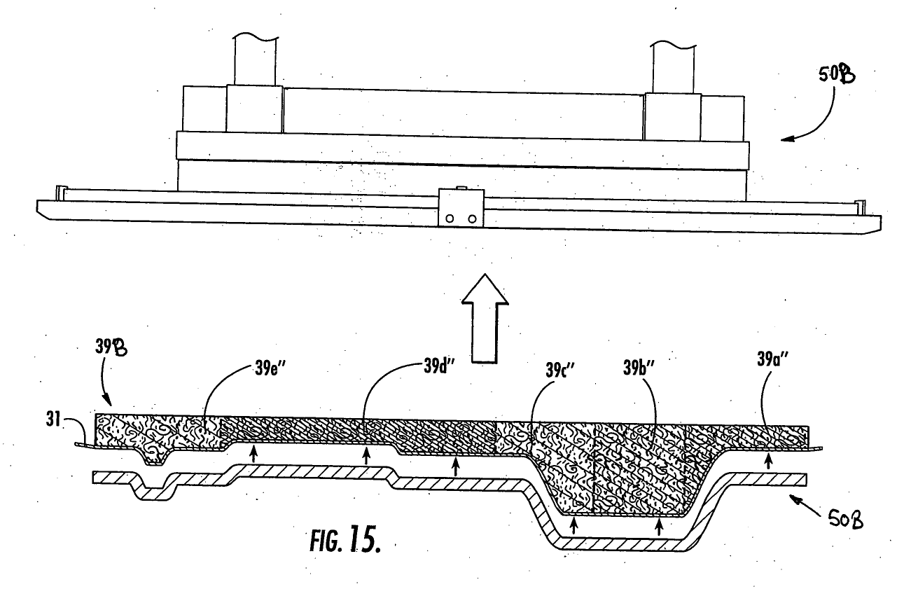

FIGS. 14-15 illustrate a mold 50B configured to mold a preform 18B (FIG. 14) having a partially contoured configuration into a compressed configuration 39B with non-constant cross-sectional dimensions (FIG. 15). In the illustrated embodiment of FIGS. 14-15, the decoupler 39B has a contoured configuration but sections 39a″-39e″ have different respective densities and different respective heights after molding to provide a wide range of acoustic impedance.

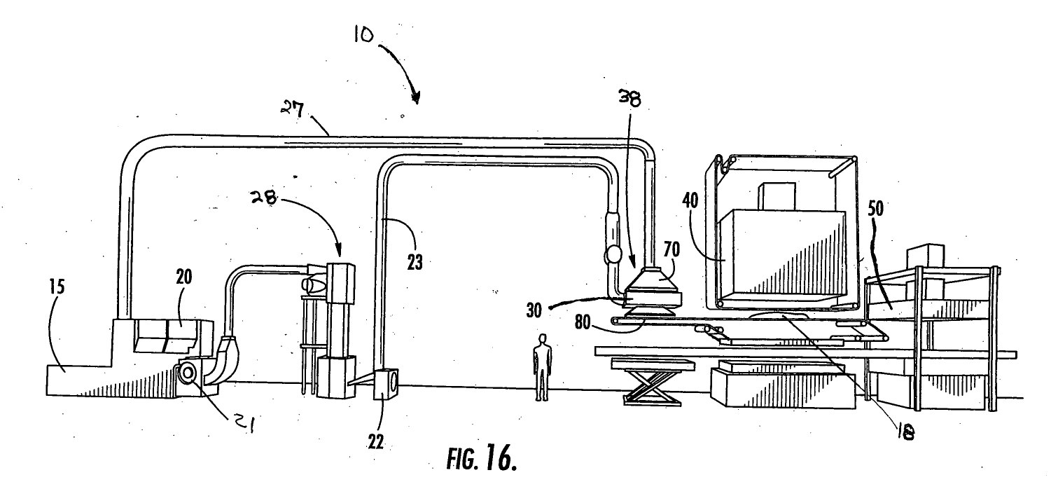

FIG. 16 is a schematic illustration of a preferred assembly line system 10 for mass-producing decouplers for vehicle interior trim components, according to embodiments of the present invention. The illustrated system 10 functions similarly to system 10 of FIG. 2. Preferably, fiber bales are broken apart and opened via bale breaker/fiber opener 15, 20. A fan 21 supplies the loose fibers to blower 22 via accumulator 28. A blower 22 feeds the open fibers into an enclosure 30 via duct 23. A vacuum hood 70 positioned above enclosure 30 removes airborne fibers that emanate from the perforated portion 38 of the enclosure 30 and returns them for reuse via duct 27 to the opening station 20. A conveyor system 80, preferably including an endless belt, serves as a carrier for each preform 18 formed within the enclosure 30. The conveyor transports each preform to the oven 40 and mold 50 to form a decoupler 39. In the instance where the preform is being molded to shape and attached to a trim component, such as a carpet or dash insulator, the trim component may be heated in parallel with the preform in the oven 40 by supplying both components via a carrier such as endless belts or webs and heating both materials in parallel, for instance from both sides. Upon sufficient heating, the preform and trim component are mated together and supplied to the mold 50 for forming.

In a particularly preferred embodiment, a carpet section may be used as the carrier for forming the preform so that the carpet and preform may be heated together in an oven and the heated combination transferred to a forming mold which forms the combination into a three dimensional configuration in a minimal number of operations.

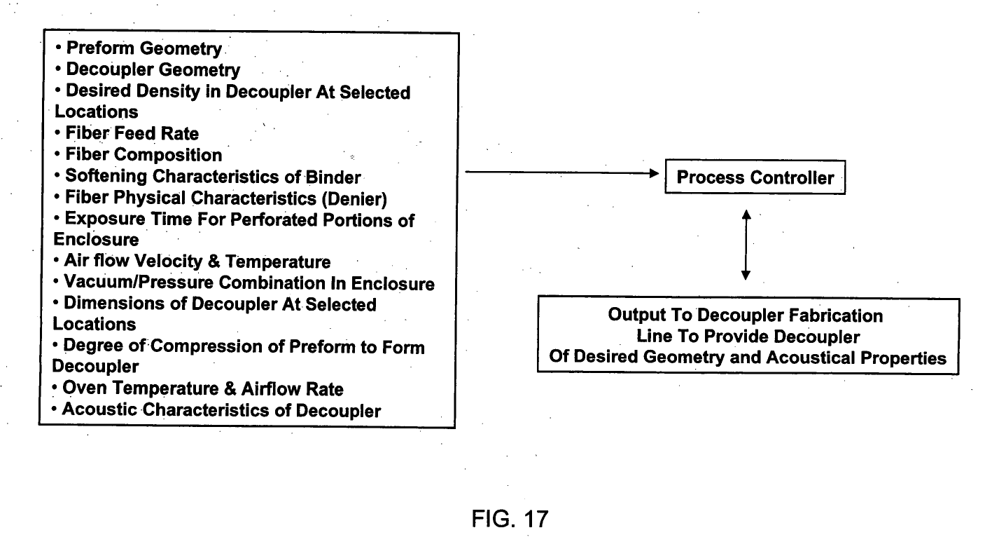

FIG. 17 illustrates that the present invention may be automated through a process controller (computer) which has inputs of the indicated variables, such as preform geometry, decoupler geometry, desired density in decoupler at selected locations, material or fiber feed rate, material or fiber composition, softening characteristics of the binder, fiber denier, exposure time for perforated portions of the enclosure, air flow velocity and temperature, vacuum/pressure combination in the enclosure, dimensions of the decoupler at selected locations, degree of compression of the preform to form the decoupler, oven temperature and air flow rate and the desired acoustic characteristics of the decoupler, etc. The inputting of this information is then evaluated and outputted to the decoupler fabrication line to provide a preform and/or decoupler of a desired density, geometry and/or acoustical properties.

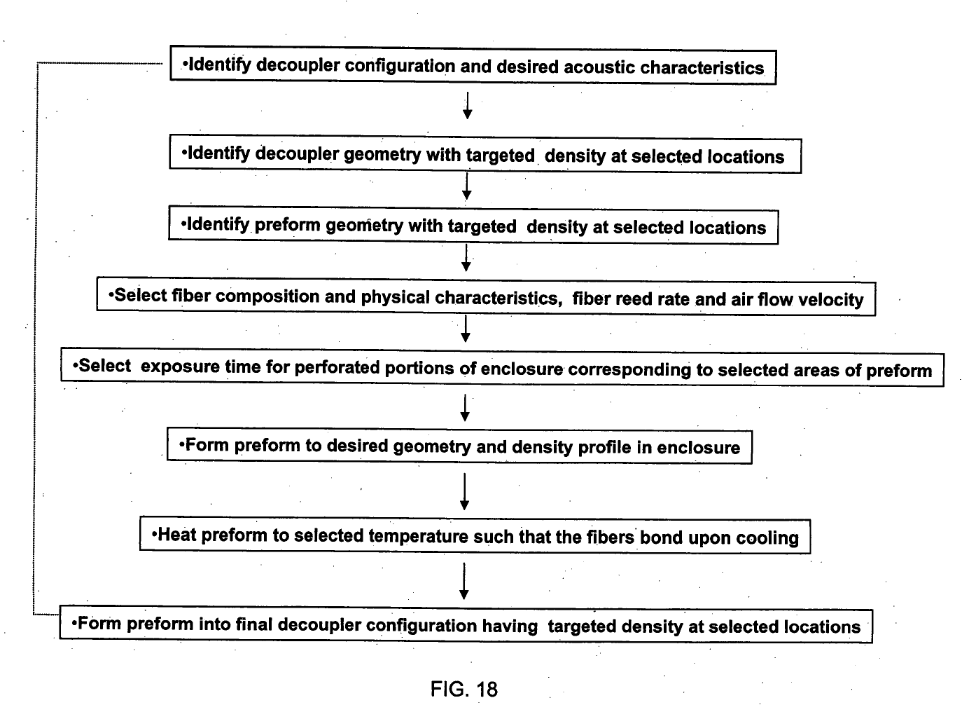

FIG. 18 illustrates in exemplary embodiment the process control features which may take place using the process controller of the present invention. For example, one may identify a decoupler configuration with desired acoustic characteristics at selected locations. The processor then compares this input with information stored in a machine readable memory which identifies a density and thickness that corresponds to the desired acoustic characteristics at such selected locations. The controller then determines a suitable preform geometry with density requirements at the selected location to achieve the decoupler acoustic requirements. The processor then selects the appropriate process inputs of the system to create such preform that provides the desired decoupler. This includes selecting material or the preferred fiber composition and physical characteristics (e.g., denier) and material or fiber feed rate and air flow velocity to deliver to the system enclosure. In addition, the processor may select and control the exposure time for perforated portions of the enclosure corresponding to the areas of the preform that must be formed with a selected density. The processor then selects and controls the formation of the preform including the density profile of the preform that is desired. The processor also then selects and controls the temperature of the oven that heats the preform to a selected temperature such that the materials or fibers bond upon cooling. The processor selects and controls the time and pressure in the mold that is utilized to form the preform into the final decoupler.

Accordingly, in connection with the above, the present invention also contemplates a machine-readable medium whose contents cause a system to perform a method of forming a decoupler for a vehicle interior trim component. The medium acts to store a desired acoustical characteristics of a decoupler configuration in the medium and to store processing variables required to provide acoustical characteristics of a decoupler. The medium then selects certain processing variables required to form the decoupler with the desired acoustical characteristics. The medium then outputs the processing variables to the system to perform the method of forming the decoupler.

It will be appreciated that the functionality described for the embodiments of the invention may be implemented by using hardware, software or combination of hardware and software. If implemented by software, a processor and machine-readable medium are required. The processor may be of any type of processor capable of providing the speed and functionality required by the embodiments of the invention. For example, the processor could be a processor from the Pentium® family of processors made by Intel Corporation, or the family of processors made by Motorola. Machine-readable media include any media capable of storing instructions adapted to be executed by a processor. Some examples of such media include, but are not limited to, read-only memory (ROM), random-access memory (RAM), programmable ROM (PROM), erasable programmable ROM (EPROM), electronically erasable programmable ROM (EEPROM), dynamic RAM (DRAM), magnetic disk (e.g., floppy disk and hard drive), optical disk (e.g. CD-ROM), and any other device that can store digital information. In one embodiment, the instructions are stored on the medium in a compressed and/or encrypted format.

In one non-limiting example, a bale of fibers comprising 45% (wt) of a bicomponent sheath/core fiber composition was utilized, wherein the sheath comprised an amorphous polyester with Tg of about 70° C. with an inner core of crystalline PET with a Tm of about 220° C. Such bicomponent was mixed with 55% (wt) of a cotton/polyester blend, wherein the polyester comprised recycled polyester fibers. The bales were broken into loose fibers and the fibers supplied via an air stream to an accumulator which provided temporary storage of the fibers for feeding into the enclosure for forming the preform. The fibers were then introduced into the enclosure at a rate of about 20 lbs/minute for a duration of about 35 seconds, onto a scrim carrier. A series of hinged panels were sequentially opened and closed to expose perforated areas of the enclosure as the fibers were introduced. This provided a preform having dimensions of about 8 feet long by 6 feet wide by 8 inches thick, having a basis weight of about 133 g/ft². The preform was transferred to an oven which was supplied with hot air at a temperature of about 340° F., blown upwardly through the scrim carrier and into the preform for about 35 seconds. The heated preform was compressed about 40-60% while in the oven. The heated preform was then transferred to a forming mold and pressed into the desired shape, wherein the preform was further densified within its cross-section to provide the desired acoustic characteristics.

Thus the invention provides a means to manufacture acoustic decouplers for use in motor vehicles which may be formed into complex configurations and provide different levels of sound attenuation in various areas of the decoupler by varying both the density and the cross-sectional thickness of the decoupler, locally. Further, the decoupler may be attached to a trim component as part of the molding process to provide a finished product ready for installation in the vehicle, having a configuration matching an area which requires specific sound attenuation.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of manufacturing a decoupler for a vehicle interior trim component, comprising:
conveying materials into an enclosure to form a preform having a shape of the enclosure, wherein the enclosure has a perforated portion and at least one panel movable relative to the enclosure so as to selectively expose portions of the perforated portion;
heating the preform to a temperature such that adjacent materials may bond to one another upon cooling; and
forming the heated preform into a predetermined three-dimensional decoupler configuration via a mold.

2. The method of claim 1, wherein the enclosure has a contoured shape.

3. The method of claim 1 wherein the materials comprise thermoplastic material, thermoset material, fibrous material, foam, woven material, nonwoven material, fiber of any type, and combinations thereof.

4. The method of claim 3, wherein the fibers may comprise any of natural fibers, synthetic fibers, recycled fibers, bicomponent fibers and blends thereof.

5. The method of claim 4, wherein the fibers comprise shoddy fibers.

6. The method of claim 1, wherein the materials are conveyed into the enclosure in a substantially loose state.

7. The method of claim 1, wherein a carrier layer is disposed within the enclosure and wherein the preform is supported by the carrier layer.

8. The method of claim 7, wherein the carrier layer comprises an acoustic web of material, scrim or contoured trim piece.

9. The method of claim 7, wherein the carrier layer comprises scrim material.

10. The method of claim 7, wherein the carrier layer comprises an endless belt.

11. The method of claim 1, wherein the materials are conveyed into the enclosure from more than one direction.

12. The method of claim 1, wherein the materials are conveyed into the enclosure so as to form a preform having first and second portions said portions having different respective densities.

13. The method of claim 12, wherein the materials are conveyed into the enclosure so as to form a preform having first and second portions said portions having different respective cross-sectional dimensions, and wherein the forming step comprises forming the heated preform into a predetermined three-dimensional decoupler configuration.

14. The method of claim 12, wherein the materials are conveyed into the enclosure so as to form a preform having first and second portions said portions having substantially the same respective cross-sectional dimensions, and wherein the forming step comprises forming the heated preform into a predetermined three-dimensional decoupler configuration.

15. The method of claim 1, further comprising the ascertaining of acoustic properties of a vehicle passenger compartment to identify portions of the decoupler requiring enhanced sound attenuation.

16. The method of claim 1, wherein the conveying of materials into the enclosure includes the adjusting of the rate of movement of the at least one panel to adjust density in identified portions of the decoupler requiring enhanced sound attenuation.

17. The method of claim 15, wherein the ascertaining of acoustic properties of the vehicle passenger compartment comprises identifying portions of the decoupler at which sound within a predetermined frequency range is directed at an intensity level that exceeds a threshold intensity level.

18. The method of claim 15, wherein the ascertaining of acoustic properties of the vehicle passenger compartment comprises generating a sound intensity map of at least a portion of the vehicle passenger compartment.

19. The method of claim 1 wherein the materials are heated as they are conveyed into said enclosure.

20. The method of claim 1 including a plurality of panels movable relative to the enclosure.

21. The method of claim 20 wherein said panels are hingedly moveable and selectively opened and closed.

22. The method of claim 1 wherein said enclosure includes a partition.

23. The method of claim 1 wherein the density of the preform may be varied as the at least one panel is moved to expose the perforated portion of the enclosure.

24. The method of claim 1 wherein the step of heating the preform to a temperature such that adjacent materials may bond to one another upon cooling comprises supplying the preform with materials comprising an amorphous polymer and a crystalline polymer wherein the amorphous polymer is heated above its glass transition temperature (Tg) and the crystalline polymer is heated to a temperature below its melting point (Tm).

25. A system for manufacturing a preform comprising:
an enclosure comprising a perforated portion and at least one panel movable relative to the enclosure so as to selectively expose portions of the perforated portion;
a feeder configured to introduce materials into the enclosure to form a preform having a shape of the enclosure wherein the density of the preform within the enclosure may be varied by moving the at least one panel to expose the perforated portion of the enclosure as materials are blown into the enclosure;
an oven configured to heat the preform to a temperature such that adjacent materials may bond to one another upon cooling.

26. The system of claim 25 wherein the system includes a plurality of panels movable relative to the enclosure.

27. The system of claim 26 wherein said panels are hingedly movable and capable of being selectively opened and closed.

28. The system of claim 25 further comprising
a mold that forms the heated preform into a predetermined three-dimensional decoupler configuration.

29. The system of claim 25 wherein the materials comprise thermoplastic material, thermoset material, fibrous material, foam, woven material, nonwoven material, fiber of any type, and combinations thereof.

30. The system of claim 29, further including a bale cutter to provide fibers to said feeder.

31. The system of claim 25 further including a process controller wherein said process controller includes inputting of processing variables and said process controller outputs control parameters to said system to provide a desired geometry and density for said preform.

32. The system of claim 28 further including a process controller wherein said process controller includes inputting of processing variables and said process controller outputs control parameters to said system to provide a desired geometry and density for said decoupler.

33. A machine-readable medium whose contents causes a system to perform a method of forming a decoupler for a vehicle interior trim component comprising
storing a desired acoustical characteristics of a decoupler configuration in said medium;
storing processing variables required to provide said desired acoustical characteristics of said decoupler;
selecting at least one processing variable required to form said decoupler with said desired acoustical characteristics;
outputting said at least one processing variable to said system to perform said method of forming said decoupler.

34. A decoupler for a vehicle interior trim component, comprising a molded preform having the shape of an enclosure from which it was formed, the preform comprising thermally bonded materials having first and second portions with different respective densities.

35. The decoupler of claim 34 wherein the materials comprise thermoplastic material, thermoset material, fibrous material, foam, woven material, nonwoven material, fiber of any type, and combinations thereof.

36. The decoupler of claim 34 wherein said preform having the shape of an enclosure comprises materials conveyed into said enclosure in a substantially loose state.

37. The decoupler of claim 34, wherein the first and second portions have different cross-sectional dimensions.

38. The decoupler of claim 34, wherein the first and second portions have substantially the same cross-sectional dimension.

39. The decoupler of claim 35, wherein the fibers may comprise any of natural fibers, synthetic fibers, bicomponent fibers, recycled fibers and blends thereof.

40. The decoupler of claim 35, wherein the fibers comprise shoddy fibers.

41. The decoupler of claim 35, wherein different denier fibers comprise said first and second portions.

42. A method of manufacturing a decoupler for a vehicle interior trim component, comprising:
conveying materials into an enclosure to form a preform having a shape of the enclosure, wherein the enclosure has a panel containing one or a plurality of movable portions relative to the enclosure so as to selectively expose portions of the enclosure, wherein the density of the preform may be varied as the at least one or plurality of movable portions are moved to expose a portion of the enclosure;
heating the preform to a temperature such that adjacent materials may bond to one another upon cooling; and
forming the heated preform into a predetermined three-dimensional decoupler configuration via a mold.

43. The method of claim 42 wherein the materials comprise thermoplastic material, thermoset material, fibrous material, foam, woven material, nonwoven material, fiber of any type, and combinations thereof.

44. The method of claim 42 wherein said step of conveying materials includes introducing said materials in a substantially loose state by blowing said materials into said enclosure with an air stream, and said one or plurality of moveable portions upon moving defines an opening in said panel to expose a portion of the enclosure, wherein said openings further include a structure to regulate the amount of air that blows through and the amount of material retained in the enclosure.

45. The method of claim 42 wherein vacuum is included to convey said materials into said enclosure to form said preform.

46. The method of claim 42 wherein said step of conveying materials includes introducing said materials in a substantially loose state by blowing said materials into said enclosure with an air stream and applying a vacuum to convey said materials.

47. A method of manufacturing an article having a controlled density, comprising: conveying materials into an enclosure to form a preform having a shape of the enclosure, wherein the enclosure has a perforated portion and at least one panel movable relative to the enclosure so as to selectively expose portions of the perforated portion; and
heating the preform to a temperature such that adjacent materials may bond to one another upon cooling.

48. The method of claim 47 further comprising forming the heated preform into a predetermined three-dimensional configuration via a mold.
